(19) United States
(12) Patent Application Publication
(10) Pub. No.: US 2025/0335728 A1
(43) Pub. Date: Oct. 30, 2025

(54) RADIO IDENTIFICATION UNIT AND ELECTRONIC LOCK

(71) Applicant: Astra Gesellschaft fur Asset Management mbH & Co. KG, Barsinghausen (DE)

(72) Inventors: Stefan Moller, Barsinghausen (DE); Anatoli Stobbe, Barsinghausen (DE)

(73) Assignee: Astra Gesellschaft fur Asset Management mbH & Co. KG, Barsinghausen (DE)

(21) Appl. No.: 19/191,097

(22) Filed: Apr. 28, 2025

(30) Foreign Application Priority Data
Apr. 30, 2024 (DE) 10 2024 112 172.6

(51) Int. Cl. G06K 7/10; G01J 5/00; G07C 9/32; H04W 4/80

(52) U.S. Cl. CPC G06K 7/10128; G01J 5/0025; G07C 9/32; H04W 4/80

(57) ABSTRACT

The invention relates to a radio identification device including a radio identification receiver and a proximity detector connected to the radio identification receiver, wherein the proximity detector includes a pyroelectric PIR sensor for detecting an approach of a person located in the vicinity of the radio identification receiver and is configured to activate the radio identification receiver when a person approaching the proximity detector is detected. The PIR sensor includes two sensor elements arranged horizontally adjacent to each other having a sensor surface sensitive to infrared waves covered by a cover that is at least partially transparent for infrared wavelengths, wherein a vertical web is arranged between the pair of sensor elements in the gap between the cover and a platform of the PIR sensor carrying the sensor elements.

### FIELD OF THE INVENTION

The invention relates to a radio identification device comprising a radio identification receiver and a proximity detector connected to the radio identification receiver, wherein the proximity detector comprises a PIR sensor for detecting the presence of a person located in the vicinity of the radio identification receiver and is configured to activate the radio identification receiver when a person approaching the proximity detector is detected.

### BACKGROUND OF THE INVENTION

PIR sensors are pyroelectric sensors or passive infrared sensors that have sensor elements made of pyroelectric material in the form of a thin polarized crystal. Thermal radiation in the infrared wavelength range incident onto the pyroelectric material is absorbed. The resulting temperature difference affects the polarization of the crystal and causes a change of the electrical potential that can be measured with an amplifier. Commercially available PIR sensors have two adjacent sensor elements and a pre-amplifier that are integrated in a hermetically sealed transistor housing. The sensor elements are covered with optics typically embodied as a plastic Fresnel lens.

CN 112252855 A discloses an electronic lock comprising a PIR module and a video camera. The lock is woken up when the presence of a person is detected and a picture or video of the person is taken and transmitted to a server via a wireless data connection.

One problem with PIR sensors is their high sensitivity. When electronic locks are installed on doors in a corridor, people are detected, even when they pass the door and do not want to operate the electronic lock. In heavily frequented corridors, such as for example in hotels, hospitals, care facilities, offices and the like, this leads to a higher battery energy consumption and a too short service life of the power supply.

### SUMMARY OF THE INVENTION

The present invention provides an improved radio identification device and an improved electronic lock with such a radio identification device.

It is proposed that the PIR sensor comprises two sensor elements arranged horizontally adjacent to each other and having a sensor surface sensitive to infrared waves covered by a cover that is at least partially transparent for infrared wavelengths, wherein a vertical web is arranged between the pair of sensor elements in the gap between the cover and a platform of the PIR sensor carrying the sensor elements.

The separation of a pair of horizontally adjacent sensor elements and the cover of the sensor elements reduces the sensitivity and thus the range of the PIR sensor and at the same time ensures sufficient sensitivity for detecting a person approaching the radio identification device, in order to activate the radio identification receiver in time before reaching the radio identification device and to read out the identification with little or preferably no delay. The separation of the pair of horizontally adjacent sensor elements by the interposed vertical web reduces the detection range and increases the sensitivity in the near field. The thermal radiation impinges at an angle, in particular in the near field. The web more strongly deflects the thermal radiation away from the sensor element, which, due to the web, is oriented further away from the thermal radiation. Thus, a greater temperature difference can be detected by the two sensors in the near field.

The vertical arrangement of the web with respect to the horizontal arrangement of the two adjacent sensor elements of a pair means that the web is arranged transversely to the alignment of the two adjacent sensor elements, between which the web is positioned.

The term “horizontal” refers to a substantially horizontal position, whereby a certain inclination in a tolerance range of up to about 20° is included in the position. The vertical position is substantially perpendicular thereto, whereby also in this case the vertical position includes a certain tolerance of about 70° to 110° to the horizontal position.

The PIR sensor may comprise two pairs of sensor elements arranged vertically on top of each other, whereby the respective sensor elements of a pair are arranged horizontally adjacent to each other. Thereby, the two respective horizontally adjacent sensor elements may be inversely polarized with respect to each other and the sensor elements arranged vertically on top of each other may be inversely polarized with respect to each other.

A horizontal web may be arranged between the pairs of sensor elements that are arranged vertically on top of each other in the gap between the cover and the platform of the PIR sensor.

The PIR sensor may comprise four sensor elements arranged in a 2×2 matrix. By doing so, the PIR sensor maybe arranged diagonally with its sensor elements, whereby the horizontal web covers a pair of sensor elements that are centered vertically on top of each other. One respective sensor element of the horizontally adjacent pair of sensor elements not covered by the web may be arranged on each side of the web.

The cover may be made of a polyethylene-containing (PE-containing) material, preferably of high-density polyethylene (HDPE). With such a cover, the detection range may be significantly limited compared to different optics that increase the range, such as in particular a Fresnel lens. The cover is preferably a flat or planar (non-curved) plate, which at the same time serves to protect the proximity detector from external factors, in particular from environmental factors (dust, moisture, mechanical damage). The cover is not a lens, in particular not a Fresnel lens.

The vertical and/or horizontal web may be made of a material that reflects and/or absorbs infrared wavelengths. A web made of metal is particularly advantageous. It may, for example, be made of aluminum. This also includes aluminum alloys. The web may be integrally formed with a frame portion of the same material or incorporated into a frame portion made of a different material, such as plastic. An embodiment of the web made of a plastic material that contains metal-containing pigments or pigments that reflect or absorb infrared wavelengths or made of a plastic material that is impermeable to thermal radiation is also conceivable.

The proximity detector may have a frame body with a bottom conically tapering towards the PIR sensor. This allows the detection angle to be adjusted and the sensitivity to be further reduced to a shorter distance from the PIR sensor.

The web may be formed integrally with the frame body or may be connected to the frame body. The PIR sensor may be form-fittingly accommodated in the frame body. This allows aligning the PIR sensor with its sensor elements in a stable position with respect to the web.

The radio identification receiver may comprise an RFID reader for reading active RFID transponders. The active RFID transponder is only queried by the proximity detector by emitting electromagnetic waves after it wakes up, thus reducing energy consumption.

The radio identification receiver may comprise a near field communication reader for radio identification of near field communication transmitters.

The electronic lock comprises an electronically operable locking unit and such a radio identification device. The locking unit is operable to open the electronic lock when detecting the presence of a person in the vicinity of the radio identification receiver and receiving and checking identification with the radio identification device.

The electronic lock may have a door handle, a lock latch, and an actuator-operable coupling between the door handle and the lock latch, whereby the door handle may be selectively connected to or disconnected from the lock latch of the electronic lock. Thus a door equipped with such an electronic lock that has latched into the lock latch and is therefore closed may be opened simply by pressing down the door handle. However, this is only possible if the approach of a person is detected by the PIR sensor, the radio identification receiver is woken up and activated and an identification of the person was read and checked by means of the radio identification receiver via radio data transmission, in order to engage the coupling between the door handle and the lock latch upon successful identification.

### BRIEF DESCRIPTION OF THE DRAWINGS

The invention will be explained in more detail below by means of an exemplary embodiment together with the accompanying drawings. In these:

FIG. 1 illustrates a block diagram of a radio identification device;

FIG. 2 illustrates a front view of an electronic lock;

FIG. 3 illustrates a front view of a section of the electronic lock with an uncovered proximity detector;

FIG. 4 illustrates a top view of a frame portion with a vertical web and section B-B for the proximity detector;

FIG. 5 illustrates a sectional side view of the frame portion of FIG. 4 along section B-B;

FIG. 6 illustrates a top view of a mounting plate for the proximity detector with section B-B;

FIG. 7 illustrates a sectional side view of the electronic lock in the region of the proximity detector along section B-B;

FIG. 8 schematically illustrates a proximity detector with example sensor output signals when approaching at a distance of 0.5 and one meter;

FIG. 9 schematically illustrates another embodiment of a proximity detector with a quad PIR sensor and example sensor output signals when approaching at a distance of 0.5, 1.0, and 1.5 meters;

FIG. 10 schematically illustrates another embodiment of the proximity detector with quad PIR sensor and horizontal and vertical webs;

FIG. 11 schematically illustrates another embodiment of a quad PIR sensor diagonally arranged with a horizontal web.

### DETAILED DESCRIPTION OF THE INVENTION

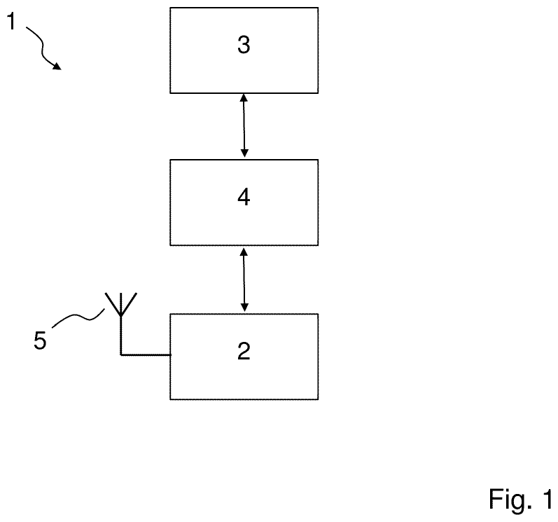

FIG. 1 shows a block diagram of radio identification device 1 comprising radio identification receiver 2 and proximity detector 3. Proximity detector 3 is configured as a PIR sensor and responds when a person approaches proximity detector 3 at a predefined distance of approach. To this end, a threshold value may be preconfigured and stored in programmable control unit 4 (e.g. a microcontroller or microprocessor) of radio identification device 1. radio identification device 1 comprises antenna 5 for receiving electromagnetic signals. Here, an active RFID transponder may be signaled by an energy field and the identification signal sent by the RFID transponder may be received.

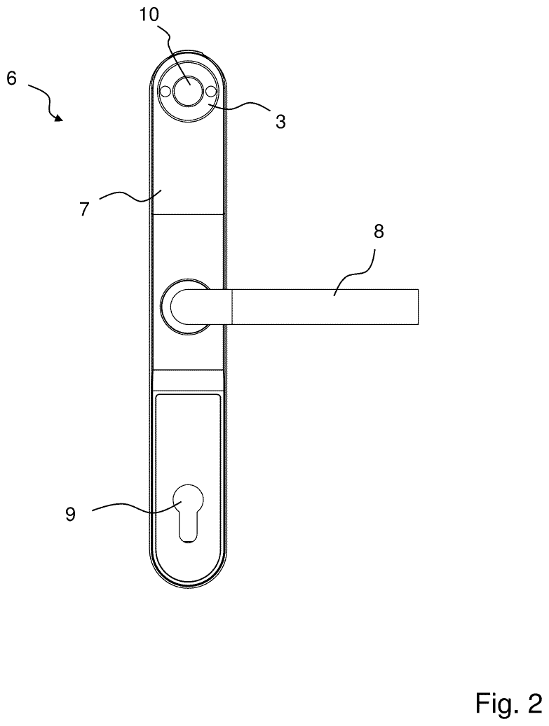

FIG. 2 illustrates a front view of electronic lock 6. The electronic lock comprises escutcheon 7, on which door handle 8 is pivotably mounted. Below door handle 8, keyhole 9 is formed in escutcheon 7.

Escutcheon 7 comprises proximity detector 3 in a vertical direction above door handle 8, said proximity detector being covered with planar cover plate 10. Cover plate 10 is not curved and is not configured as a lens. In particular, cover plate 10 is not a Fresnel lens. This reduces the detection range and the detection distance within which the approach of a person towards electronic lock 6 may be detected.

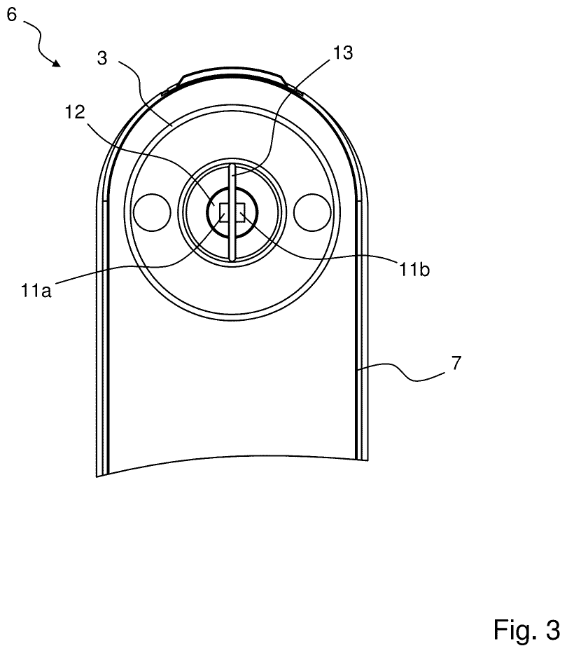

FIG. 3 illustrates a front view of a section of electronic lock 6 with uncovered proximity detector 3. Proximity detector 3 comprises a pyroelectric sensor, that is, a PIR sensor with at least two sensor elements 11a, 11b arranged horizontally adjacent to each other on platform 12. To this end, sensor elements 11a, 11b are integrated on a substrate of a PIR sensor mounted within a housing. It can be seen that web 13 reflecting and/or absorbing thermal radiation is arranged between the pair of horizontally adjacent sensor elements 11a, 11b. Said web essentially limits the detection angle of sensor elements 11a, 11b in a horizontal direction. An approach by a person, which usually does not occur directly from the front, thereby leads to a different intensity of thermal infrared radiation onto the two sensor elements 11a, 11b. The difference is amplified and output as a sensor signal, such that an activation signal activating radio identification receiver 2 when a threshold value predefined in accordance with a desired response sensitivity or trigger distance is exceeded.

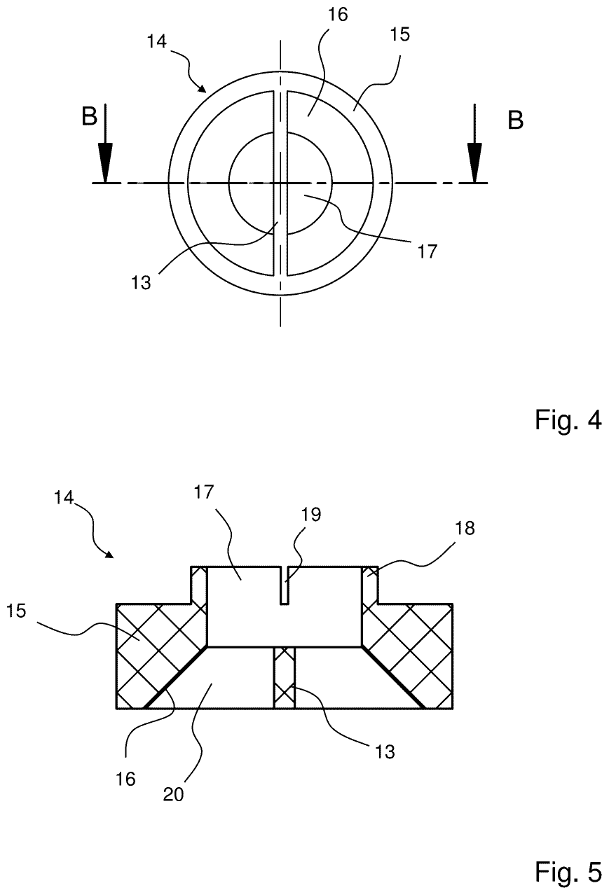

FIG. 4 illustrates a top view of frame portion 14 of proximity detector 3 and section B-B. Frame portion 14 comprises vertical web 13 extending between cylindrical frame body 15 in a vertical direction. Cylindrical frame body 15 has conically inclined bottom 16 and central opening 17 in bottom 16. A cylindrical housing of a PIR sensor may be inserted into central opening 17. This fixes frame portion 14 with its web 13 in the correct position on the PIR sensor.

FIG. 5 illustrates a sectional side view of frame portion 14 along section B-B. It can be seen that frame body 15 of frame portion 14 includes bottom 16 tapering towards 17 in a funnel-shaped manner, that is, conically tapering towards opening 17. With the dimensioning of frame portion 14 and the funnel shape, the detection angle may be set at the factory as required. Tubular extension 18 adjoins frame body 15 and surrounds central circular opening 17. Extension 18 may have slot 19, into which a tab of the PIR sensor may protrude, in order to mount the PIR sensor properly positioned with an alignment of horizontally adjacent sensor elements 11a, 11b of a pair that is transverse to the direction of extension of web 13.

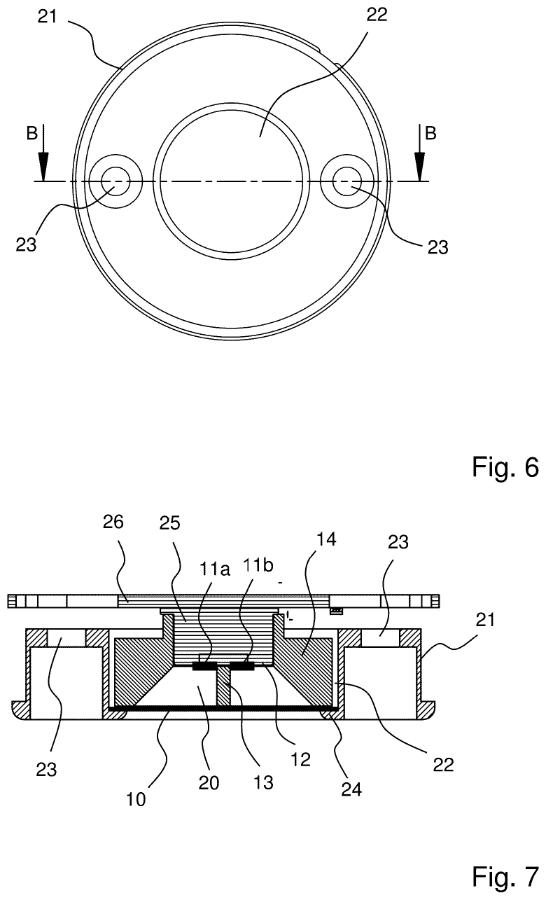

FIG. 6 illustrates a top view of mounting plate 21 for proximity detector 3 with section B-B. Mounting plate 21 has central through opening 22 and two mounting holes 23 arranged on the common sectional line B-B.

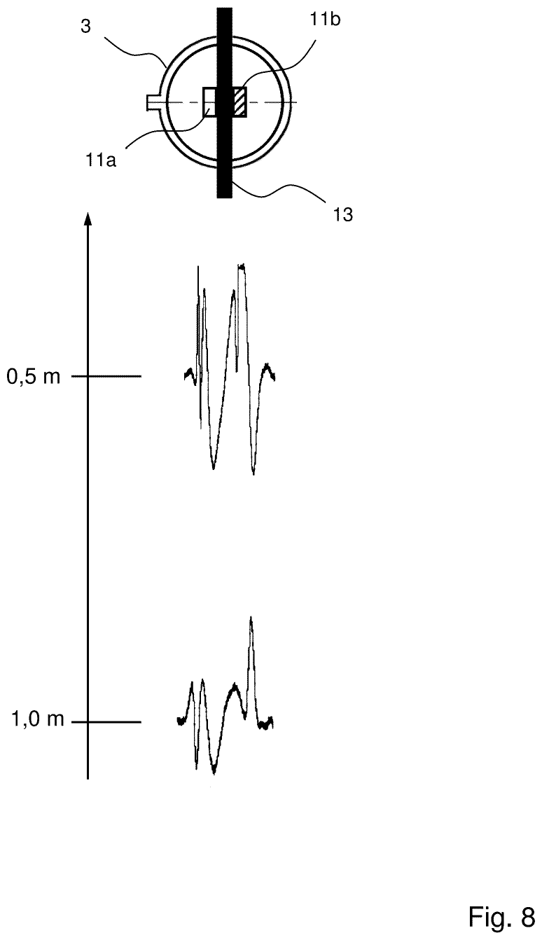

FIG. 7 illustrates a sectional side view of electronic lock 1 in the region of proximity detector 3 along section B-B. Mounting plate 21 includes circumferential flange 24 protruding into through opening 22. Cover plate 10 rests on flange 24. Frame portion 14 is received in through opening 22 and rests on top of cover plate 10. Web 13 of frame portion 14 extends from cover plate 10 to platform 12 of PIR sensor 25, on which sensor elements 11a, 11b are disposed. The web is positioned between the pair of adjacent sensor elements 11a, 11b and extends transversely to the plane of platform 12 and cover plate 10 in gap 20. PIR sensor 25 is soldered onto electronic circuit board 26 and received in opening 17 of frame portion 14.

Cover plate 10 may be a separate component from frame portion 14. However, it is also conceivable that cover plate 10 is integrally formed with frame portion 14, for example as an injection-molded polyethylene component.

Web 13 reflecting and/or absorbing thermal radiation may be formed as a separate component of frame portion 14, for example of a different material. A metallic web 13, such as a polished aluminum sheet component, may achieve an additional optical gain by means of reflection. However, it is also advantageous to manufacture frame portion 14 as a metal component integrally with web 13. Web 13 and frame portion 14 may also be made of a plastic material that is largely impermeable to infrared radiation.

FIG. 8 illustrates proximity detector 3 with two horizontally adjacent sensor elements 11a, 11b and web 13 vertically arranged with respect thereto between sensor elements 11a, 11b. Vertical web 13 extends transversely to the alignment of the pair of adjacent sensor elements 11a, 11b.

Two sensor output signals are shown by way of example, which were measured during the approach at a perpendicular distance of 0.5 m and 1 m from PIR sensor 25 or its platform 12 carrying sensor elements 11a, 11b, respectively. Sensor elements 11a, 11b of a pair are hereby inversely polarized with respect to each other, as indicated by the white area for one polarization and the diagonally hatched area for the opposite polarization. As a result, the signals cancel each other out when approached from the front, and a differential signal of the two individual sensor signals of sensor elements 11a, 11b is formed and amplified by the pre-amplifier of the PIR sensor. A sensor output signal over time is shown when a person approaches a door equipped with radio identification device 1 at normal walking speed. Proximity detector 3 is mounted at a height of approximately 1.15 m above the ground.

It will be apparent that the sensitivity of PIR sensor 25 is clearly reduced as desired and in a meaningful way for power-saving control of radio identification device 1, such that the amplified sensor output signal has a significantly smaller amplitude at a distance of one meter as compared to a distance of 0.5 meters. When radio identification device 1 is woken up when approaching at a distance of approximately 0.5 m, there is sufficient time to signal an RFID transponder in the near field, read and check the identification and engage electronic lock 6, such that the authorized person can operate the door handle and open the door without delay when reaching the door.

One problem with conventional PIR sensors 25 is that the sensor signals of the inversely polarized sensor elements of adjacent sensor elements 11a, 11b cannot be read individually. Rather, sensor elements 11a, 11b of PIR sensors 25 are integrated and connected to a pre-amplifier, such that only one sensor output signal is provided, which does not allow any physical adjustment of the sensitivity.

By means of intermediate web 13 for separating the detection areas of the two interconnected sensor elements 11a, 11b, the sensitivity of PIR sensor 25 may now be adjusted, such that it reliably ensures power-saving activation only in the event of an approach in the desired close range.

Cover plate 10 forms a separator together with vertical web 13, which limits and restricts the respective detection range for the two sensor elements 11a, 11b of dual PIR sensor 25 to the right or to the left side, respectively. As a matter of principle, it does not matter whether a digital or an analog sensor is employed.

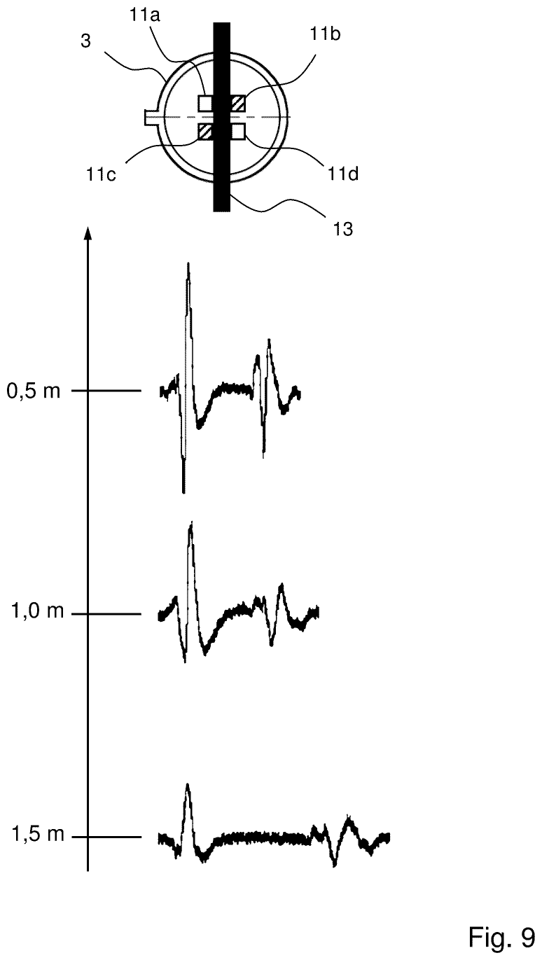

FIG. 9 schematically illustrates another preferred embodiment of proximity detector 3 with quad PIR sensor 25 and example sensor output signals when approaching at a distance of 0.5, 1.0, and 1.5 meters. In this embodiment, quad PIR sensor 25 includes four sensor elements 11a, 11b, 11c, 11d arranged in a 2×2 matrix. One pair of inversely polarized sensor elements 11a, 11b and 11c, 11d, respectively, is arranged on one horizontal line. Sensor elements 11a, 11c and 11b, 11d that are arranged vertically adjacent are also polarized inversely with respect to each other. Vertical web 13 is arranged in the gap between two respective sensor elements 11a, 11b, 11c, 11d of a pair. The use of such a quad PIR sensor 25 appears unsuitable at first, as the signals of the two inversely polarized sensor elements 11a, 11c and 11b, 11d on top of each other, respectively, cancel each other out at least in part.

However, it has been shown that there is a clear increase of the signal amplitude from a distance of 1.5 meters to a distance of 0.5 meters, such that the sensitivity is significantly reduced with increasing distance. Similarly, the signal characteristics between the first signal peak and the temporally subsequent signal peak differ significantly with increasing distance. This time and signal behavior may also be utilized for signal evaluation for proximity detection at close range.

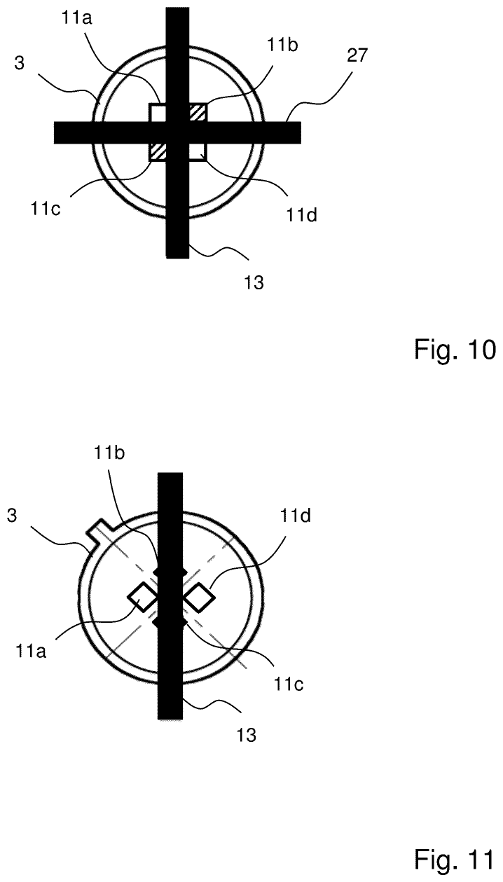

FIG. 10 illustrates another embodiment of proximity detector 3 with quad PIR sensor 25, where the two pairs of horizontally adjacent sensor elements 11a, 11b and 11c, 11d are separated from each other by additional horizontal web 27.

However, when using this quad PIR sensor 25, it may also be advantageous to cover either the upper or the lower horizontal row of sensor elements 11a, 11b or 11c, 11d, respectively, in order to measure with only one pair of sensor elements 11a, 11b or 11c, 11d. This may be achieved by partially closing opening 17 of frame portion 14.

FIG. 11 illustrates another embodiment of proximity detector 3 including quad PIR sensor 25 arranged diagonally with respect to the vertical alignment of web 13. Thereby, web 13 covers two sensor elements 11b and 11c, or 11a and 11d now vertically arranged on top of each other. These are generally polarized in the same way. Thus, the web is now arranged between horizontally adjacent sensor elements 11a, 11d or 11b, 11c, respectively. These two sensor elements 11a, 11d or 11b, 11c not covered by web 13 are generally polarized the same way. This makes it possible to achieve a sensor output signal different from the first embodiment with dual PIR sensor 25, said signal allowing limiting the detection of a person approaching to the close range of proximity detector 3.

### LIST OF REFERENCE NUMERALS

1 radio identification device
2 radio identification receiver
3 proximity detector
4 control unit
5 antenna
6 electronic lock
7 escutcheon
8 door handle
9 keyhole
10 cover plate
11a, 11b sensor elements
12 platform
13 vertical web
14 frame portion
15 frame body
16 bottom
17 opening
18 tubular extension
19 slot
20 gap
21 mounting plate
22 through opening
23 mounting hole
24 flange
25 PIR sensor
26 circuit board
27 horizontal web

What is claimed is:

1. A radio identification device comprising:
a radio identification receiver; and
a proximity detector connected to the radio identification receiver, wherein the proximity detector comprises a pyroelectric PIR sensor for detecting an approach of a person located in the vicinity of the radio identification receiver and is configured to activate the radio identification receiver when a person approaching the proximity detector is detected, wherein the PIR sensor comprises two sensor elements arranged horizontally adjacent to each other having a sensor surface sensitive to infrared waves covered by a cover that is at least partially transparent for infrared wavelengths, wherein a vertical web is arranged between the pair of sensor elements in the gap between the cover and a platform of the PIR sensor carrying the sensor elements.

2. The radio identification device according to claim 1, wherein the PIR sensor comprises two pairs of sensor elements arranged vertically on top of each other, wherein the respective sensor elements of each pair are arranged horizontally adjacent to each other.

3. The radio identification device according to claim 2, wherein the two respective horizontally adjacent sensor elements other are polarized inversely with respect to each other and the respective sensor elements arranged vertically on top of each other are polarized inversely with respect to each other.

4. The radio identification device according to claim 2, comprising a horizontal web arranged between the pairs of sensor elements that are arranged vertically on top of each other in the gap between the cover and the platform of the PIR sensor.

5. The radio identification device according to claim 1, wherein the PIR sensor comprises four sensor elements arranged in a 2×2 matrix, wherein the PIR sensor is arranged with its sensor elements in a diagonal manner, the vertical web covers a pair of sensor elements arranged centered vertically on top of each other and one respective sensor element each of the pair of horizontally adjacent sensor elements not covered by the web is arranged on each side of the vertical web.

6. The radio identification device according to claim 1, wherein the cover is made of a polyethylene-containing material.

7. The radio identification device according to claim 1, wherein the cover is a planar cover plate.

8. The radio identification device according to claim 1, wherein the web is made of a material reflecting and/or absorbing infrared wavelengths, in particular of a metal, such as aluminum, or of a plastic containing metallic pigments or containing pigments that reflect or absorb infrared wavelengths.

9. The radio identification device according to claim 1, wherein the proximity detector comprises a frame body with a bottom conically tapering towards the PIR sensor.

10. The radio identification device according to claim 1, wherein the web is integrally formed with the frame body or connected to the frame body.

11. The radio identification device according to claim 1, wherein the radio identification receiver comprises an RFID reader for reading active RFID transponders.

12. The radio identification device according to claim 1, wherein the radio identification receiver comprises a near field communication reader for reading active near field communication transmitters.

13. The radio identification device according to claim 1, wherein the radio identification device comprises a battery as a power supply.

14. An electronic lock comprising an electronically operable locking unit and a radio identification device according to claim 1, wherein the locking unit is operable to open the electronic lock when detecting the presence of a person in the vicinity of the radio identification receiver and receiving and checking an identification with the radio identification device.

15. The electronic lock according to claim 14, comprising a door handle, a lock latch, and an actuator-operable coupling between the door handle and the lock latch, wherein the door handle may be selectively connected to or disconnected from the lock latch of the electronic lock.

16. The radio identification device according to claim 6, wherein the polyethylene-containing material comprises high-density polyethylene.
